(19) United States
(12) Patent Application Publication
(10) Pub. No.: US 2003/0120510 A1
(43) Pub. Date: Jun. 26, 2003

(54) System for separate shipping of passenger baggage

(76) Inventor: Gregg Panek, Bannockburn, IL (US)

Correspondence Address: Justin B. Rand, Brinks Hofer Gilson & Lione, NBC Tower, Suite 3600, P.O. Box 10395, Chicago, IL, 60610, US

(21) Appl. No.: 10/324,370

(22) Filed: Dec. 20, 2002

Related U.S. Application Data
(60) Provisional application No. 60/343,451, filed on Dec. 21, 2001.

(51) Int. Cl. G06F 17/60

(52) U.S. Cl. 705/1; 705/5

(57) ABSTRACT

A method for shipping passenger baggage separately from a ticketed passenger transportation vehicle is disclosed. The method comprises delivering the passenger's baggage to an appropriate processing location where the baggage will be linked to the passenger's transportation vehicle. The passenger will receive a receipt for the baggage and the baggage will be transported to an appropriate destination by transportation that is separate from the passenger's transportation vehicle.

### REFERENCE TO RELATED APPLICATIONS

This application claims the benefit of provisional application No. 60/343,451 entitled “System for Prior Day Shipping of Passenger Baggage” and filed Dec. 21, 2001, the entirety of which is incorporated herein by reference.

### FIELD OF THE INVENTION

This invention relates to a method for shipping airline passenger baggage separately from passenger flights.

### BACKGROUND

Currently, passenger baggage is shipped with passengers on passenger flights. This system has many disadvantages.

First, checked baggage is an ideal vector for explosives or other terrorist devices. As it is shipped on the same flights as passengers, human casualties are maximized.

Second, the process of loading and unloading the planes is dependent on the timely arrival of the flights. Thus, personnel responsible for performing these tasks have idle time in which they wait for flights and are paid but not working.

Third, long check-in lines result from passengers checking their baggage prior to departure and numerous personnel are required to process the passengers and baggage. As a result, passengers are required to arrive hours before their departure times to ensure that they are able to check their baggage and arrive at their departure gate on time.

Fourth, passengers have long waits for their baggage while airline personnel unload arriving flights and transport baggage to carousels. Thus, it takes longer for passengers to reach their ultimate destinations and is frustrating and inconvenient to travelers.

Fifth, the system lacks flexibility. When a passenger's plans change, it is problematic to retrieve baggage from the plane prior to takeoff. The checked luggage must be unloaded, the passenger's baggage found and removed and then the plane must be reloaded. This results in delays and hassle to both the passengers and the airline.

Lastly, with the Dec. 31, 2002 Federal Aviation Administration imposed deadline for airlines to implement bomb detection devices for checked baggage, the burden of checking baggage for transport on passenger flights will only increase. It will take longer for the baggage to be processed, require more airline personnel and result in an overall increased financial burden to airports and airlines and consumers.

Accordingly, there is a need for a method that improves upon the current system for shipping passenger baggage.

### SUMMARY

In order to address the shortcomings of the current system, an improved method for shipping passenger baggage is described below.

According to a first aspect of the present invention, a method for shipping of airline passenger baggage separately from passenger flights is disclosed. The method comprises delivering passenger baggage to an appropriate processing location where the baggage will be linked to the passenger's flight. The passenger will receive a receipt for the baggage and the baggage will be transported to an appropriate destination by a transportation vehicle that is separate from the passenger's flight. The baggage will then be directed to an appropriate pick-up location.

In an alternative embodiment, the present invention comprises scheduling both departing and return flight baggage pickup for at least one day before travel as well as scheduling departing and return flight delivery of passenger baggage. The baggage will be transferred to a departure airport and then transported to the destination airport. The baggage will be directed to and picked up at an appropriate pick-up location.

In a second alternative embodiment, the present invention comprises the scheduling of both departing and return flight pick-up of passenger baggage for at least one day before travel as well as scheduling departing and return flight delivery of the passenger baggage. The pick-up and delivery will be linked to the passenger's flight. The scheduled date and time of the pick-up and delivery of the baggage will be entered into a tracking system and a tracking code will be assigned to the baggage. The baggage will be labeled with the tracking code and the passenger will receive a receipt. The baggage will be scanned when it arrives at the departure airport and will be routed to the destination airport by a carrier that is separate from the passenger's flight. The baggage will be delivered to an appropriate final location for pick-up.

### BRIEF DESCRIPTION OF THE FIGURES

FIG. 1A shows a flow chart of a method for shipping passenger baggage separately from passenger flights.

FIG. 1B is a continuation of the flow chart in FIG. 1A.

### DETAILED DESCRIPTION OF THE PRESENTLY PREFERRED EMBODIMENTS

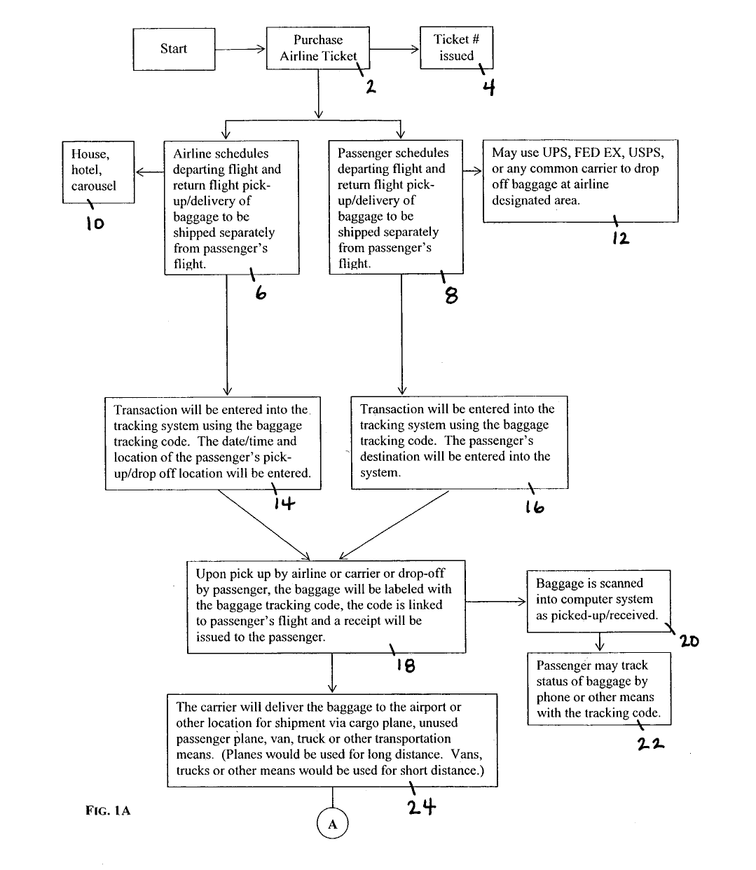

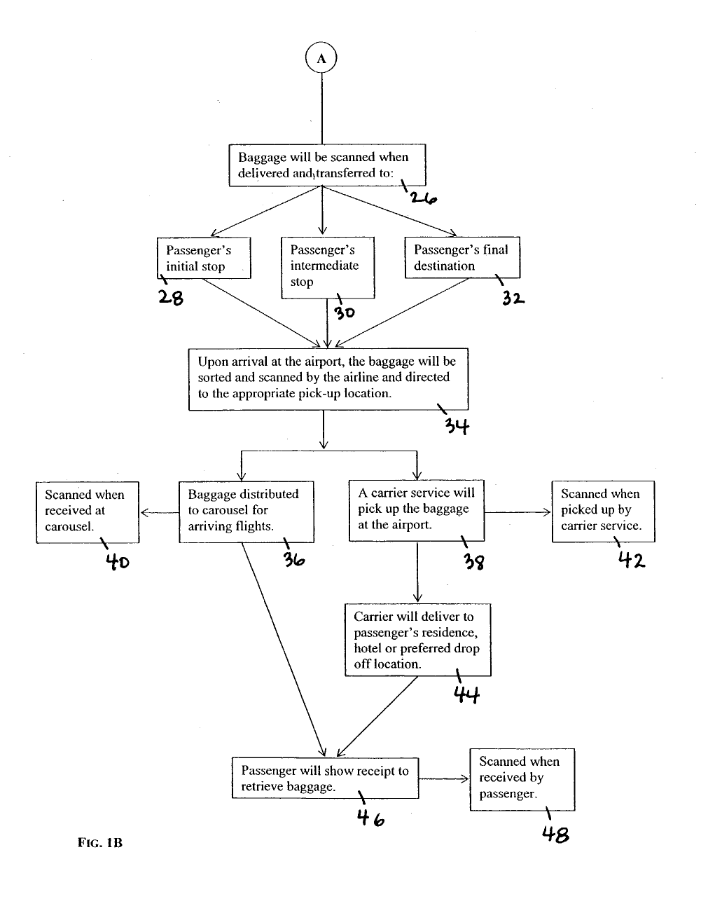

As shown in FIGS. 1A and 1B, an airline passenger would book a domestic or international flight in a conventional manner, such as with the airline, through a travel agent, or online (at step 2). Subsequently, an airline ticket whether, paper, paperless, or any other form, would be issued (at step 4).

If the ticket is purchased up to one week in advance, the airline will schedule the pick up and/or delivery of the baggage. The airline will schedule baggage pick up from the passenger's home, hotel or other location with a designated lockout time for baggage to be ready at least one day before the passenger's flight. If a common carrier is used to transport the baggage to the departure airport, the airline will reimburse the carrier for expenses (at steps 6, 10).

On the other hand, if the ticket is purchased less than one week in advance, the passenger will arrange ground transportation for the baggage to the departure airport at his own expense (at step 8).

Alternatively, the passenger may drop off the baggage at a designated location such as UPS, FEDERAL EXPRESS, a United States Postal Office, or another designated location near the airport. The passenger may also arrange for pick-up via an expedited service or arrange for a common carrier to pick up the baggage at their home, hotel or other location (at step 12).

Once the baggage has been picked up by a common carrier or dropped off by the passenger, it will be entered into a tracking system, labeled and linked to the passenger's flight (at steps 14, 16, 18). The label may have a bar code or other form of tracking code on it. The passenger will receive a receipt for the baggage which will have a corresponding identification code or tracking code that will enable the passenger to go online to track his baggage. The receipt may also have a phone number for the passenger to call and check the baggage transportation status (at step 22). This tracking code will also be utilized to properly route the baggage to the appropriate destination. Conventional shipping programs can be used for this step.

Once the baggage has been processed, which entails labeling and linking it to the passenger's flight, the carrier will deliver the baggage to the departure airport or designated baggage area for shipment via a cargo plane, an unused passenger plane, van, truck, train, ship or other shipping method. Vans or trucks could be used for short distances and other vehicles may be used for longer distances (at step 24). Preferably, the vehicles used for shipping the baggage will be cargo type vehicles not be carrying passengers. The baggage will be logged into a tracking system, such as with optical scanning devices, at each step of the shipping process, thus allowing the approximate location and estimated time of arrival to be reported via phone or other method (at steps 20, 26, 34, 40, 42, 48). This is similar to package tracking used by common carriers such as UPS or FEDERAL EXPRESS.

These shipping vehicles may make multiple stops, dropping off baggage at the appropriate destinations. Baggage may be transferred to a first stop, an intermediate stop or a final stop per itinerary. Thus, a carrier may make multiple stops and the baggage may be dropped off at the most convenient location along its route. For example, baggage destined for St. Louis from Milwaukee may be placed on a truck or train along with baggage destined for Chicago. The truck or train will be routed through Chicago on its way to St. Louis, and the appropriate baggage will be delivered at each point in the trip. In addition, different pieces of baggage from one passenger may take different routes to the final destination. For example, on a trip from New York to Los Angeles, passenger's baggage A, B and C may take different paths. Baggage A may be directed on a non-stop route to Los Angeles. Whereas, baggage B may take a northern route and baggage C may take a more southern route. All of the baggage A, B, and C however, would arrive at the Los Angeles destination prior to the arrival of the passenger. Numerous variations of the routing of baggage belonging to one passenger are possible. The routing of a passenger's bags over different routes may be based on size, weight, available spacing or other parameters.

Upon arrival at the destination airport, the baggage will be sorted and directed to the appropriate final location for pick-up (at step 34). The baggage will be distributed to the appropriate carousel for arriving passenger flights (at step 36). The baggage could also be delivered to another appropriate pick-up location designated by each airline. If the baggage is delivered to a location other than a carousel, the passenger will show their receipt to retrieve their baggage (at step 48). Alternatively, a carrier service will pick up the baggage and deliver the baggage to a residence, hotel or the passenger's preferred, predetermined location (at step 38). When the carrier delivers the baggage, the passenger will show the receipt to retrieve the baggage from the carrier and the receipt will be scanned into the tracking system to confirm the final delivery of the baggage (at steps 44, 46, 48).

As will be described, the present method eliminates many of the disadvantages found in the system currently used for shipping passenger baggage. For example, the present method provides the important benefit of significantly reducing the threat of a terrorist or other individual hiding an explosive device in checked baggage to cause explosion or destruction of a passenger plane. The safety of everyone will be increased, since all major baggage will be eliminated from passenger flights. In addition to increasing the safety of passenger flights, monetary benefits to airlines and passengers will be realized.

Airlines using this system will benefit in several ways. For instance, fewer security personnel will be required at the passenger drop-off terminals as passengers will not need to unload baggage and traffic will move through these areas more smoothly. Also, fewer airline personnel will be required to check in passengers as there will be no baggage to check and the passenger check-in process will be more efficient. This will result in savings in time for ticket agents such that they may spend more time screening passengers and asking intelligent questions. This method will also eliminate long lines at check-in counters and allow travelers to arrive at airports only one hour prior to departure.

In addition, idle time of airline personnel responsible for loading, unloading and sorting baggage will be eliminated. Thus, these employees who currently spend time waiting for flights to arrive will receive firm schedules and only be paid for time spent working. Also, fewer employees will be required to perform these tasks as time constraints will be removed, thus saving the airlines money.

Airlines will also benefit from airplanes being lighter without the passengers' checked baggage, thus requiring less fuel. Further, planes may be reconfigured to add passenger seating in the space previously occupied by cargo. Although the cost of extra cargo flights or other transportation of the baggage is an added expense, it will be far outweighed by the increase in safety of airline passenger flights.

Passengers will be more satisfied with the airlines as they no longer have arrive hours before their flight, wait in long check-in lines or wait at baggage carousels for their checked baggage to arrive. Thus the savings in time that is currently spent waiting in lines will be significant. Further, skycap services may still be used to retrieve baggage. Therefore, this system will decrease the overall travel time required to arrive at the passenger's destination and increase the passenger's satisfaction with the airline.

Additionally, this system is more flexible than the current method of baggage transportation. A change in passenger travel plans will not result in delays to the passenger or the scheduled flight as there will be no need to remove the passenger's baggage from the passenger plane. Thus, the hassle and delays in the current system will be eliminated.

Furthermore, with the Dec. 31, 2002 deadline for airlines to implement explosive detection systems for all checked baggage, this system will save airlines and airports time and money. Shipping baggage separately from passenger flights will eliminate the time constraints caused by the need to x-ray baggage prior to take-off, thereby reducing the number of employees required to perform the task as well as the number of x-ray machines required, thereby saving the airline money in both labor and equipment costs. Also, it is conceivable that since no baggage will be on passenger flights, the requirement of x-raying all checked baggage will be removed.

This system will provide benefits to passengers as well. Passengers will be able to arrive at the airport closer to departure time since checking in baggage will not be required. They will receive enhanced service since all baggage will have been sorted and distributed hours prior to passenger arrival at the destination and there will be no waiting at carousels for baggage to arrive. Further, carry-on bags will still be allowed on passenger flights, so passengers may have necessities with them. Therefore, the overall travel time of passengers will be reduced while at the same time the safety and convenience of passenger travel will be enhanced.

This system may also accommodate a traveler with multiple destinations. For a traveler with more than one stop, it would be possible to get expedited service of the baggage to the next destination via other smaller cargo carriers on the same day.

In addition, the present system may be adapted for passengers traveling by train, ship, or bus. The savings in time and increased safety realized by shipping baggage separately from passenger flights would also be realized by passengers utilizing these and other modes of transportation.

As a result of this improved method of shipping baggage, a whole new industry could be developed regarding passenger baggage transportation. Further, new types of baggage may be developed to accommodate this new system. For example, baggage may be reconfigured to fit together so that multiple pieces of baggage may be shipped as one unit. It may also be redesigned to accommodate the space and shape of the transportation vehicles that will be used.

In this new method, the baggage to be shipped separately from passenger flights includes any passenger luggage, parcel, suitcase, belonging or possession. The baggage may be shipped to the passenger's initial, intermediate or final destination.

It is therefore intended that the foregoing detailed description be regarded as illustrative rather than limiting, and that it be understood that it is the following claims, including all equivalents, that are intended to define the spirit and scope of this invention.

I claim:

1. A method for shipping baggage separately from a ticketed passenger transportation vehicle, the method comprising:
delivering passenger baggage to a processing location;
linking said baggage to a ticketed passenger transportation vehicle;
issuing a receipt for said baggage;
transporting said baggage to a destination separately from said ticketed passenger transportation vehicle; and
directing said baggage to a pick-up location.

2. The method of claim 1 wherein said linking comprises entering a tracking code for said baggage into a tracking system, entering said passenger's transportation vehicle information into said tracking system, and tagging said baggage with said tracking code.

3. The method of claim 1 wherein transporting said baggage comprises using at least one of a cargo plane, unused passenger plane, truck, van, train and ship.

4. The method of claim 1 further comprising transporting said baggage to multiple stops between said processing location and said destination.

5. The method of claim 1 wherein a passenger remotely checks a status of said baggage.

6. The method of claim 5 wherein remotely checking said status comprises at least one of said passenger checking online and by phone.

7. The method of claim 1 wherein said pick-up location comprises an airport.

8. The method of claim 1 wherein said pick-up location comprises one of said passenger's home and hotel.

9. The method of claim 1 wherein said ticketed passenger transportation vehicle comprises at least one of a plane, train, bus and ship.

10. A method for shipping baggage for a passenger of an airline separately from passenger flights, the method comprising:
scheduling departing flight and return flight baggage initial pick-up;
scheduling departing flight and return flight delivery of said baggage in a transportation vehicle that is separate from a passenger flight;
transferring said baggage to a departure airport;
linking said initial pick-up and said delivery to said passenger flight;
transporting said baggage to a destination airport;
directing said baggage to a final pick-up location; and
picking up said baggage at said final pick-up location.

11. The method of claim 10 wherein said airline schedules said departing flight and said return flight initial pick-up for at least one day before travel.

12. The method of claim 10 wherein said passenger schedules said departing flight and said return flight initial pick-up for at least one day before travel.

13. The method of claim 10 wherein a common carrier transfers said baggage to said departure airport.

14. The method of claim 10 wherein said final pick-up location comprises a baggage carousel at said destination airport.

15. The method of claim 13 wherein said common carrier comprises a courier service.

16. The method of claim 10 wherein transferring said baggage to said departure airport comprises said passenger dropping off said baggage at said departure airport.

17. The method of claim 16 wherein said passenger drops off said baggage at a drop-off site located in a location other than said departure airport and said baggage is subsequently delivered to said departure airport by at least one of said departure airport personnel and a common carrier.

18. The method of claim 10 wherein said initial pick-up location comprises one of said passenger's home and hotel.

19. The method of claim 10 wherein delivery of said baggage comprises one of said passenger's home and hotel.

20. The method of claim 10 wherein said baggage comprises at least one of said passenger luggage, parcel, suitcase, belonging and possession to be shipped separately from said passenger flight to at least one of said passenger's initial, intermediate and final destination.

21. A method for shipping baggage separately from a passenger flight, the method comprising the steps of:
scheduling departing flight and return flight pick-up of baggage for at least one day before travel;
scheduling departing flight and return flight delivery of said baggage;
entering the scheduled date and time of said pick-up and said delivery of said baggage into a tracking system;
linking said pick-up and said delivery to a passenger flight;
assigning a tracking code to said baggage entered into said tracking system;
labeling said baggage with said tracking code;
supplying a receipt for said baggage;
scanning said baggage when it arrives at a departure airport;
routing said baggage to a destination airport via a transportation vehicle that is separate from said passenger flight; and
delivering said baggage to a final location for pick-up.

22. The method of claim 21 wherein said passenger delivers said baggage to said departure airport.

23. The method of claim 21 wherein a common carrier delivers said baggage to said departure airport.

24. The method of claim 21 further comprising said receipt having at least one of an identification code and a phone number to track a status of said baggage.

25. The method of claim 21 wherein said final location for baggage pick-up comprises a carousel at said destination airport.

26. The method of claim 21 wherein said final location for pick-up comprises one of said passenger's home and hotel.

27. The method of claim 21 wherein said passenger shows said receipt to retrieve said baggage at said final pick-up location.

28. The method of claim 21 further comprising scanning said receipt into said tracking system upon final pick-up of said baggage.

29. The method of claim 21 wherein said destination airport comprises at least one of a first stop, intermediate stop and final stop on said carrier's route.

30. The method of claim 21 wherein said scheduled airline flight comprises an international flight.

31. The method of claim 26 wherein a common carrier delivers said baggage from said destination airport to said final location for pick-up.

32. The method of claim 31 wherein said common carrier comprises a courier service.

33. The method of claim 21 wherein at least one of said passenger and said carrier drop off said baggage at a location at said departure airport.

34. The method of claim 21 wherein said baggage comprises at least one of said passenger luggage, parcel, suitcase, belonging and possession to be shipped separately from said passenger flight to at least one of said passenger's initial, intermediate and final destination.
